(19) United States
(12) Patent Application Publication
(10) Pub. No.: US 2004/0258586 A1
(43) Pub. Date: Dec. 23, 2004

(54) Air cleaning machine

(76) Inventor: Jung-Huang Hung, Gaohsiung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/601,154

(22) Filed: Jun. 20, 2003

(51) Int. Cl. B01J 19/08; B01J 19/12

(52) U.S. Cl. 422/186.07

(57) ABSTRACT

An air cleaning machine includes a main body having a front side formed with at least one air outlet, an ozonizer mounted in the main body and containing ozone, and a fan mounted in a rear side of the main body to blow the ozone in the ozonizer outward through the air outlet of the main body. Thus, the air cleaning machine can blow the ozone to replenish the negative potential of the human body, thereby achieving the air cleaning and sterilizing effects.

### BACKGROUND OF THE INVENTION

1. Field of the Invention

The present invention relates to an air cleaning machine, and more particularly to an air cleaning machine that can achieve the air cleaning and sterilizing effects.

2. Description of the Related Art

A conventional air cleaner can provide an air cleaning effect. However, the conventional air cleaner cannot provide a sterilizing effect, thereby limiting the versatility of the conventional air cleaner.

A conventional ozonizer can provide a sterilizing effect. However, the ozonizer cannot provide an air cleaning effect, thereby greatly limiting the versatility of the ozonizer. In addition, the conventional ozonizer comprises a high pressure generator to assist the ozonizer to produce the ozone, and a pump to deliver the ozone. However, the high pressure generator easily produces a high temperature during operation, thereby affecting operation of the ozonizer.

### SUMMARY OF THE INVENTION

The primary objective of the present invention is to provide an air cleaning machine that can blow the ozone to replenish the negative potential of the human body, thereby achieving the air cleaning and sterilizing effects.

Another objective of the present invention is to provide an air cleaning machine that is provided with a fan to achieve the air cleaning and sterilizing effects without having to provide a pump, thereby decreasing consumption of the electric power and decreasing costs of fabrication.

A further objective of the present invention is to provide an air cleaning machine, wherein the air blown by the fan can deliver the ozone to achieve the sterilizing effect and can also provide a heat dissipation effect to the high pressure generator, thereby enhancing the operation efficiency of the high pressure generator.

A further objective of the present invention is to provide an air cleaning machine, wherein the negative potential generator is located adjacent to the air outlet of the main body to produce a negative potential to replenish the negative potential of the human body.

A further objective of the present invention is to provide an air cleaning machine, wherein the ozonizer can be stopped and the fan is operated successively, so that the air cleaning machine only functions as an air cleaner.

In accordance with the present invention, there is provided an air cleaning machine, comprising:

a main body having a front side formed with at least one air outlet;

an ozonizer mounted in the main body and containing ozone; and

a fan mounted in a rear side of the main body to blow the ozone in the ozonizer outward through the air outlet of the main body.

Further benefits and advantages of the present invention will become apparent after a careful reading of the detailed description with appropriate reference to the accompanying drawings.

### BRIEF DESCRIPTION OF THE DRAWINGS

FIG. 1 is a perspective assembly view of an air cleaning machine in accordance with the preferred embodiment of the present invention;

FIG. 2 is an exploded perspective view of the air cleaning machine in accordance with the preferred embodiment of the present invention; and

FIG. 3 is a side plan cross-sectional view of the air cleaning machine as shown in FIG. 1.

### DETAILED DESCRIPTION OF THE INVENTION

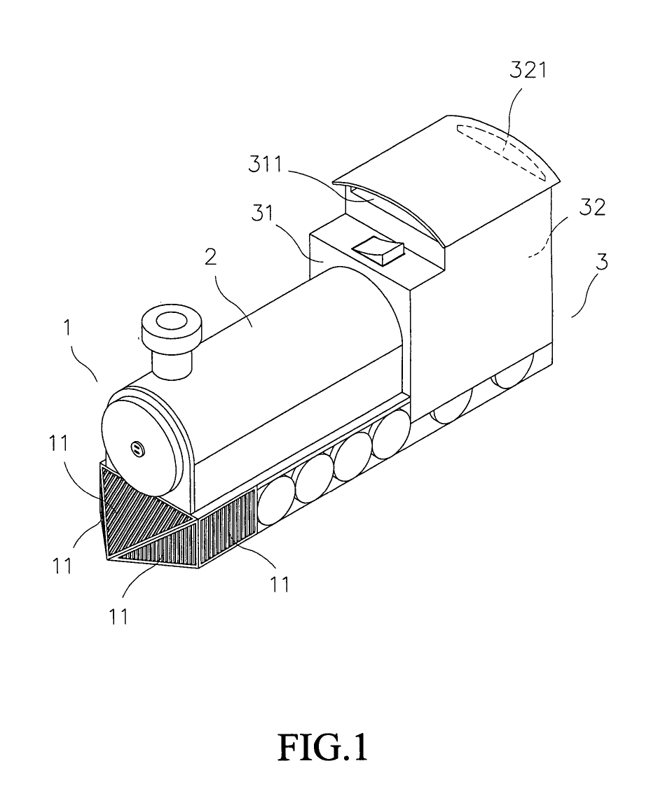

Referring to the drawings and initially to FIG. 1, an air cleaning machine in accordance with the preferred embodiment of the present invention comprises a main body 1, a front cover 2 mounted on the main body 1, and a rear cover 3 mounted on the main body 1 and combined with the front cover 2. The main body 1 has a configuration like a train. The main body 1 has a front side formed with a plurality of air outlets 11. The rear cover 3 has a front wall 31 formed with an air inlet 311 and a rear wall 32 formed with an air inlet 321.

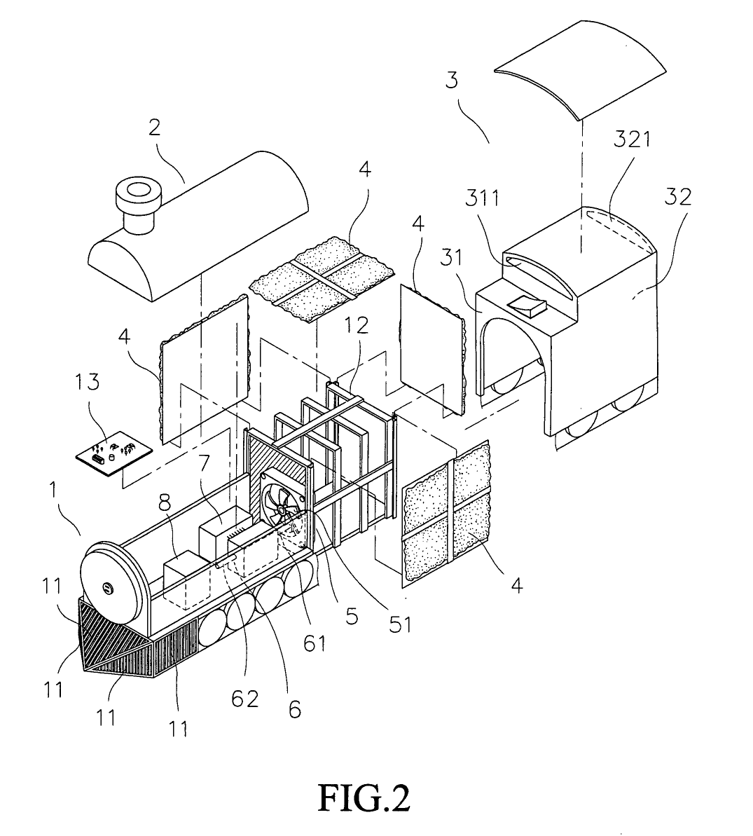

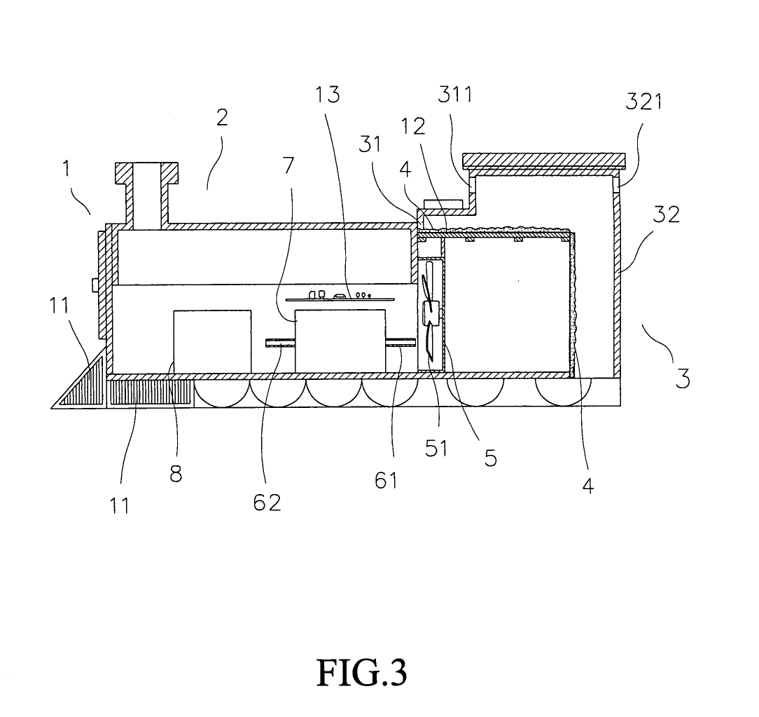

Referring to FIGS. 2 and 3 with reference to FIG. 1, the main body 1 has a rear side provided with a hollow support frame 12, and a plurality of filtering nets 4 mounted on a periphery of the support frame 12.

The air cleaning machine further comprises a fan 5 mounted on a front side of the support frame 12, an ozonizer 6 mounted in the main body 1 and located in front of the fan 5, a high pressure generator 7 mounted in the main body 1 and located in front of the fan 5, a circuit board 13 mounted in the main body 1 and located above the ozonizer 6 and the high pressure generator 7, and a negative potential generator 8 mounted in the main body 1 and located in front of the ozonizer 6 and the high pressure generator 7.

As shown in FIG. 2, the fan 5 has a plurality of blades 51 and has a periphery closely sealed in the front side of the support frame 12, so that the air entering the support frame 12 can passes through the fan 5 only to enhance the air blowing strength of the fan 5.

In addition, the ozonizer 6 has an air inlet tube 61 facing the fan 5 and an air outlet tube 62 directed toward the air outlets 11 of the main body 1. Preferably, the air inlet tube 61 of the ozonizer 6 aligns with a center line of the blades 51 of the fan 5 and is distant from the blades 51 of the fan 5 with a distance of one centimeter (1 cm), so that the air inlet tube 61 of the ozonizer 6 can obtain the optimum air inlet rate, and the ozone contained in the ozonizer 6 can be drained outward from the air outlet tube 62 of the ozonizer 6 to mix with the air.

In addition, the high pressure generator 7 is juxtaposed to the ozonizer 6. Preferably, the high pressure generator 7 has a height the same as that of the ozonizer 6. Preferably, the height of the high pressure generator 7 and the ozonizer 6 is one half of that of the fan 5.

In addition, the negative potential generator 8 is located adjacent to the air outlets 11 of the main body 1. Preferably, the negative potential generator 8 has a height the same as that of the ozonizer 6.

As shown in FIG. 3, when the switch (not shown) is started to rotate the fan 5, the ambient air is sucked into the rear cover 3 through the air inlet 311 and the air inlet 321 of the rear cover 3, then passes through the filtering net 4 into the support frame 12. Then, the fan 5 blows the filtered air toward the ozonizer 6 and the high pressure generator 7, so that the filtered air can be introduced into the air inlet tube 61 of the ozonizer 6 through the blades 51 of the fan 5. Then, the ozone contained in the ozonizer 6 can be drained outward from the air outlet tube 62 of the ozonizer 6 to mix with the air blown into the main body 1 by the fan 5, and the mixture is then drained outward from the air outlets 11 of the main body 1, so that the concentration of the ozone is reduced and will not damage the human body.

In addition, the air blown by the fan 5 can provide a heat dissipation effect to the high pressure generator 7, thereby preventing the high pressure generator 7 from producing the overheat phenomenon.

In addition, the negative potential generator 8 is located adjacent to the air outlets 11 of the main body 1 to produce a negative potential (negative ion) to replenish the negative potential of the human body.

Accordingly, the filtered air can blow the ozone to replenish the negative potential of the human body, thereby achieving the air cleaning and sterilizing effects. Thus, the air cleaning machine of the present invention is provided with a fan to achieve the air cleaning and sterilizing effects without having to provide a pump, thereby decreasing consumption of the electric power and decreasing costs of fabrication. In addition, the ozonizer 6 can be stopped during a period of time, and the fan 5 is operated successively, so that the air cleaning machine of the present invention only functions as an air cleaner.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. An air cleaning machine, comprising:
a main body having a front side formed with at least one air outlet;
an ozonizer mounted in the main body and containing ozone; and
a fan mounted in a rear side of the main body to blow the ozone in the ozonizer outward through the air outlet of the main body.

2. The air cleaning machine in accordance with claim 1, wherein the ozonizer has an air inlet tube facing the fan and an air outlet tube directed toward the air outlet of the main body.

3. The air cleaning machine in accordance with claim 2, wherein the air inlet tube of the ozonizer aligns with a center line of the fan.

4. The air cleaning machine in accordance with claim 2, wherein the air inlet tube of the ozonizer is distant from the fan with a distance of one centimeter.

5. The air cleaning machine in accordance with claim 1, further comprising a high pressure generator a high pressure generator mounted in the main body and located in front of the fan.

6. The air cleaning machine in accordance with claim 5, wherein the high pressure generator is juxtaposed to the ozonizer.

7. The air cleaning machine in accordance with claim 5, wherein the high pressure generator has a height the same as that of the ozonizer.

8. The air cleaning machine in accordance with claim 5, wherein the high pressure generator has a height one half of that of the fan.

9. The air cleaning machine in accordance with claim 1, wherein the ozonizer has a height one half of that of the fan.

10. The air cleaning machine in accordance with claim 1, further comprising a negative potential generator mounted in the main body and located adjacent to the air outlet of the main body.

11. The air cleaning machine in accordance with claim 10, wherein the negative potential generator has a height the same as that of the ozonizer.

12. The air cleaning machine in accordance with claim 1, wherein the main body has a rear side provided with a hollow support frame, and a plurality of filtering nets mounted on a periphery of the support frame.

13. The air cleaning machine in accordance with claim 12, wherein the fan is mounted on a front side of the support frame, and the ozonizer is located in front of the fan.

14. The air cleaning machine in accordance with claim 12, wherein the fan has a periphery closely sealed in the front side of the support frame.

15. The air cleaning machine in accordance with claim 12, further comprising a front cover mounted on the main body, and a rear cover mounted on the main body and combined with the front cover to encompass the support frame.

16. The air cleaning machine in accordance with claim 15, wherein the rear cover has a front wall formed with an air inlet and a rear wall formed with an air inlet.
